(19) United States
(12) Patent Application Publication
(10) Pub. No.: US 2007/0283844 A1
(43) Pub. Date: Dec. 13, 2007

(54) Release Agent and Its Use in the Production of Polyurethane Moldings

(75) Inventor: Torsten Henning, Schwerin (DE)

Correspondence Address: FROMMER LAWRENCE & HAUG, 745 FIFTH AVENUE- 10TH FL., NEW YORK, NY, 10151, US

(73) Assignee: Goldschmidt GmbH, Essen (DE)

(21) Appl. No.: 11/758,839

(22) Filed: Jun. 6, 2007

(30) Foreign Application Priority Data
Jun. 9, 2006 (DE) 10 2006 026 870.9

(51) Int. Cl. C09D 5/20; B28B 7/38; C04B 35/66; B32B 27/40

(52) U.S. Cl. 106/2; 106/38.22; 106/38.24; 106/38.25; 428/423.1

(57) ABSTRACT

The invention provides release agent dispersions for producing polyurethane moldings, substantially comprising A) at least one agent having release activity, from the group consisting of soaps, oils, waxes and silicones, and B) at least one bismuth carboxylate, and C) organic solvent, and, if desired, D) typical auxiliaries and additives.

This application claims benefit under 35 U.S.C. 119(a) of German patent application DE 10 2006 026 870.9, filed on 9 Jun. 2007.

Any foregoing applications including German patent application DE 10 2006 026 870.9, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to release agents and to their use in the production of polyurethane moldings.

It is known that the polyurethane systems used for producing moldings exhibit strong adhesion to the mold materials that are used, preferably highly thermally conductive materials such as metals. For the demolding of the polyurethane moldings, therefore, there is a need for release agents, which are applied to the mold walls that come into contact with polyurethanes and/or with the polyurethane reaction mixture.

Release agents of this kind are composed of dispersions or emulsions of waxes, soaps, oils and/or silicones in solvents such as hydrocarbons or water. Following application of the release agent to the mold, the solvent evaporates and the non-volatile substances with release activity form a thin release film so that the polyurethane molding can be removed easily from the mold after it has been produced.

In addition to the release effect that is actually needed, the release agent also takes on further functions. For instance, it also very greatly influences the surface of the polyurethane molding, which is to be fine-pored or smooth and uniform, for the purpose, among others, of ensuring that the finished moldings can be readily covered with fabrics or leather.

In the course of ever greater optimization of production rates in the automobile supplier industry, it is precisely the above-described property of the coverability of the polyurethane molding that has become an important quality feature.

One option of improving the surface quality of the polyurethane foam moldings is to use substances which catalyze and thereby accelerate the polyol-isocyanate reaction. The commercial release agents for polyurethane moldings therefore typically include what are called tin accelerants, in other words catalysts based on organotin compounds. As well as improving the surface quality, these tin accelerants also have a release assist effect, by accelerating the polyolisocyanate reaction at the interface between foam and release film. Particularly suitable are di-n-butyltin dicarboxylates, as described for example in EP 1 082 202 (U.S. Pat. No. 6,162,290). Principally dibutyltin dilaurate (DBTL) is used, as described for example in DE 35 41 513 (U.S. Pat. No. 4,783,296) or EP 0 164 501 (U.S. Pat. No. 4,609,511).

As is known, DBTL is labeled R 50/53 (dangerous for the environment, very toxic to aquatic organisms) and harbors risks to the environment during storage and transport of release agents which contain DBTL.

Consequently, many polyurethane foam molding customers, in the footwear sole or mattress sector, for example, are already demanding that the release agent used be free from tin compounds.

Moreover, the ECB (European Chemical Bureau) is undertaking a categorization which labels organotin compounds as reproductive toxins, with the R phrases R60-R61. This will affect certain di-n-butyltin dicarboxylates, among them DBTL. In that case it will be virtually impossible to use release agents including such components any longer.

It was an object of the present invention, therefore, to find external mold release agents which are free from tin compounds and yet exhibit an effective release action and a favorable influencing of the surfaces of the polyurethane moldings, in other words leaving them fine-pored, slightly open-pored and smooth and uniform.

Surprisingly, it has now been found that a dispersion of conventional substances with release activity, such as waxes, soaps, oils and/or silicones, in organic solvents together with bismuth salts of organic acids in amounts of 0.05% to 10% by weight, preferably 0.1% to 5% by weight, in particular 0.2% to 1% by weight, based on the weight of the dispersion, achieves this object. (All weight percentages in the specification are based on the weight of the dispersion)

The invention accordingly provides release agent dispersions for producing polyurethane moldings, substantially comprising:
A) at least one agent having release activity, from the group consisting of soaps, oils, waxes and silicones, and
B) at least one bismuth carboxylate, and
C) organic solvent, and, if desired,
D) typical auxiliaries and additives.

The dispersions are preferably composed of:
A) 0.5% to 40% by weight of at least one agent having release activity, from the group consisting of soaps, oils, waxes, and silicones,
B) 0.05% to 10% by weight of at least one bismuth carboxylate,
C) 0.1% to 10% by weight of auxiliaries and adjuvants,
D) organic solvent to 100% by weight.

As bismuth carboxylates it is preferred to use Bi(III) salts of organic acids R—COOH, where
R=unbranched or branched C₆ to C₂₂ hydrocarbon radical optionally containing multiple bonds, i.e., alkyl radical, alkenyl radical and/or aryl radical.

Organic acids are the monobasic fatty acids that are customary and known in this field and are based on natural vegetable or animal fats and oils having 6 to 22 carbon atoms, preferably having >=8 to 20 C atoms, in particular having 8 to 18 carbon atoms, such as caproic acid, caprylic acid, 2-ethylhexanoic acid, capric acid, neodecanoic acid, lauric acid, myristic acid, palmitic acid, palmitoleic acid, isostearic acid, stearic acid, oleic acid, linoleic acid, petroselinic acid, elaidic acid, arachidic acid, behenic acid, erucic acid, gadoleic acid, rapeseed oil fatty acid, soybean oil fatty acid, sunflower oil fatty acid, tall oil fatty acid, and also the technical mixtures obtained in the course of pressurized cleavage. In principle, all fatty acids with similar chain distribution are suitable.

The unsaturated components content of these fatty acids is adjusted—if necessary—to a desired iodine number by means of the known catalytic hydrogenation processes or is achieved by blending fully hydrogenated with unhydrogenated fatty components.

The iodine number, as a numerical measure of the average degree of saturation of a fatty acid, is the amount of iodine absorbed by 100 g of the compound for the saturation of the double bonds.

The bismuth carboxylates can be prepared from Bi(III) compounds with the organic acids R—COOH by the processes known from the literature or are available as commercial products under the respective brand names, such as bismuth trioctoate or bismuth trineodecanoate, under the brand names for example of Borchi® Kat (Borchers GmbH) or Tegokat® (Goldschmidt TIB GmbH), Neobi® 200, from Shepherd, and Coscat®, from Caschem. These substances are not classified as toxic and are not classified as dangerous for the environment.

These salts on the one hand catalyze the reaction of the polyols with the isocyanates at the interfaces of the reaction mixture/mold surface, and additionally influence the surface quality of the foam in the direction of the required celledness and structure: the latter should lie within a certain cell size (fine-celled, but no microfoam or coarse foam) and should be slightly open-pored (not closed or predominantly open). These criteria are largely practical, i.e., can be optimized by means of a few range finding tests, and make it easier to cover the molding with, for example, textile coverings.

The invention further provides for the use of these dispersions as external release agents in the production of polyurethane moldings.

As conventional substances with release activity it is possible in accordance with the invention to make use for example of:
waxes, i.e., liquid, solid, natural or synthetic waxes, also oxidized and/or partly hydrolyzed,
esters of carboxylic acids with alcohols or fatty alcohols,
metal soaps, such as alkali metal or alkaline earth metal salts of fatty acids,
oils, such as hydrocarbons which are viscous or liquid at room temperature, if desired—but not preferably—used with unsaturated oligomeric and/or polymeric hydrocarbons,
silicones, such as polydimethylsiloxanes, substituted if desired by aliphatic or aromatic hydrocarbon radicals.

Typical waxes having release activity are set out for example in the company brochures “Waxes by Clariant, production, characteristics and applications”, Clariant, May 2003, and “Formtrennmittel mit Vestowax®” (“Release Agent with Vestowax®”) Degussa, February 2001.

Solvents which can be used are preferably solvents which are free from HCFCs (hydrochlorofluorocarbons). Preference is given to using hydrocarbons having boiling ranges of 25 to 280° C., preferably 80 to 200° C., preferably with flash points >22° C., more preferably >55° C. In another embodiment of the invention, the upper limit of the flash point is 200° C. In yet another embodiment of the invention, the upper limit of the flash point is 100° C.

Examples of suitable solvents are special boiling point spirit 100/140, Shellsol® D 40 (mineral spirit hydrocarbon solvent), Exxsol® D 40 (hydrotreated heavy naphtha (petroleum)), isoparaffins such as mixtures of isoundecane and isododecane (Isopar® H), for instance, or in the form of white spirit, e.g., Kristalloel K 30.

As typical auxiliaries and additives it is possible to use one or more of the compounds that are known in the art, selected from the group consisting of polyurethane foam stabilizers, such as polysiloxane-polyether copolymers, and also talc, thickeners, silica, typical catalysts if desired, in the typical amounts of about 0.1% to 10% by weight.

The dispersions of the invention can be prepared by the processes known in the art. A preferred procedure is to introduce the substances with release activity initially, in a melted form, to introduce part of the solvent under a high shearing force, and then to add the remaining solvent together with the further components under a low shearing force.

The invention further provides for the use of the above-described release agents in the production of polyurethane moldings.

Conventionally, the mold is brought to the desired mold temperature of 40 to 80° C., preferably 45 to 75° C., and is sprayed with release agent, a certain time is allowed to pass until the majority of the solvent has evaporated, and then the reactive polyurethane system comprising polyols, polyisocyanates, and, if desired, further additives such as catalysts, foam stabilizers, and blowing agents, is pumped in. The mold is closed and, after the cure time, the mold is opened and the molding is removed.

The invention further provides for the covering of the polyurethane moldings produced using the above-described release agents with fabrics, textiles, nonwovens, leather or other covering materials, for automobile seats, upholstered furniture or mattresses, for instance.

The invention is further described by the following non-limiting examples which further illustrate the invention, and are not intended, nor should they be interpreted to, limit the scope of the invention.

### EXAMPLES

List of substances used:
microwax=commercial waxes having a solidification temperature of 50 to 90° C.,
polyethylene wax=commercial waxes having a solidification temperature of 50 to 90° C.,
hydrocarbon solvent=commercial benzine fractions with boiling ranges from 80 to 200° C.,
Tegokat® bismuth(III) neodecanoate, manufacturer: Goldschmidt TIB GmbH
Borchi® Kat bismuth(III) octoate, manufacturer: Borchers GmbH
Kosmos® 19=dibutyltin dilaurate (DBTL), manufacturer: Degussa
DC® 190=polyethersiloxane, manufacturer: Air Products
Desmophen® PU 21IK01=polyetherpolyol, manufacturer: Bayer,
Tegoamin® TA 33=polyether block foam, manufacturer: Degussa,
Tegoamin® AS-1=high resilience molded foam; methyl-amin-ether, manufacturer: Degussa,
Tegostab® EP-K-38=organically modified siloxane, manufacturer: Degussa,
Suprasec® 2412=diphenylmethane 4,4′-diisocyanate, manufacturer: Huntsman.

### Example 1

### Release Agent with Bismuth Neodecanoate

2.5% by weight of polyethylene wax (solification point 60° C.) and 2.5% by weight of microwax (solidification point 70° C.) are melted and 45% by weight of hydrocarbon (flash point 56° C.) are added. 48.5% by weight of hydrocarbon (flash point 56° C.) are admixed with 0.5% by weight of Tegokat® bismuth neodecanoate and 1% by weight of polyethersiloxane DC 190 and the mixture is added to the wax dispersion.

### Example 2

### Release Agent with Bismuth Octoate

2.5% by weight of polyethylene wax (solification point 60° C.) and 2.5% by weight of microwax (solidification point 70° C.) are melted and 45% by weight of hydrocarbon (flash point 56° C.) are added. 48.5% by weight of hydrocarbon (flash point 56° C.) are admixed with 0.5% by weight of Borchi® Kat bismuth octoate and 1% by weight of DC 190® and the mixture is added to the wax dispersion.

### Comparative Example A

### Release Agent without Catalyst

2.5% by weight of polyethylene wax (solidification point 60° C.) and 2.5% by weight of microwax (solidification point 70° C.) are melted and 45% by weight of hydrocarbon (flash point 56° C.) are added. 49% by weight of hydrocarbon (flash point 56° C.) are admixed with 1% by weight of DC 190® and the mixture is added to the wax dispersion.

### Comparative Example B

### Release Agent with Dibutyltin Dilaurate

2.5% by weight of polyethylene wax (solidification point 60° C.) and 2.5% by weight of microwax (solidification point 70° C.) are melted and 45% by weight of hydrocarbon (flash point 56° C.) are added. 48.5% by weight of hydrocarbon (flash point 56° C.) are admixed with 0.5% by weight of Kosmos® 19 and 1% by weight of DC 190® and the mixture is added to the wax dispersion.

### Release Agent Tests:

The release agents were applied by spraying using a 0.5 mm nozzle, in amounts of 20 g/m², similar to those used in practice, to metal test plates, and a foamable polyurethane system composed of 100 parts of Desmophen® PU 21IK01, 3.5 parts of water, 0.4 part of Tegomin® TA 33, 0.25 part of Tegoamin® AS-1, 0.7 part of diethanolamine, 0.5 part of Tegostab® EP-K-38, 0.2 part of acetic acid (60% in water) and 63.5 parts of Suprasec® 2412, was foamed onto these plates in a box mold at 55° C.

After curing had taken place (10 minutes), the metal plates were peeled from the foam using a spring force meter, in order to measure the extent of the release effect.

### Evaluation of the Release Tests:

| | Force for peeling | |
|---|---|---|
| Release | the metal plate | Assessment of the foam |
| agent | from the foam [kg] | surface |
| 1 | 1.0 | slightly open-pored, |
| | | readily coverable |
| 2 | 1.1 | slightly open-pored, |
| | | readily coverable |
| A | 1.5 | largely closed, difficult |
| | | to cover, since excessive |
| | | frictional forces arise on |
| | | the closed and therefore |
| | | relatively large surface |
| B | 1.0 | slightly open-pored, |
| | | readily coverable |

As is apparent from the table above, the non-toxic bismuth salts used in accordance with the invention in the release agents 1 and 2 exhibit significant technical advantages over the control without catalyst (release agent A) and are equal in technical effect to the toxic tin compounds (release agent B).

Having thus described in detail various embodiments of the present invention, it is to be understood that the invention defined by the above paragraphs is not to be limited to particular details set forth in the above description as many apparent variations thereof are possible without departing from the spirit or scope of the present invention.

We claim:

1. A release agent dispersion for producing polyurethane moldings, comprising
A) at least one agent having release activity, from the group consisting of soaps, oils, waxes and silicones, and
B) at least one bismuth carboxylate, and
C) organic solvent, and, if desired,
D) typical auxiliaries and additives.

2. The dispersion as claimed in claim 1, wherein the at least one bismuth carboxylate comprises of at least one Bi(III) salt of organic acids R—COOH, where R is an optionally branched C₈ to C₂₂ hydrocarbon radical optionally containing multiple bonds.

3. The dispersion as claimed in claim 2, wherein the at least one bismuth carboxylate is bismuth trioctoate, bismuth trineodecanoate or mixtures thereof.

4. The dispersion as claimed in claim 1 comprising
A) 0.5% to 40% by weight of at least one agent having release activity, from the group consisting of soaps, oils, waxes, and silicones, and
B) 0.05% to 10% by weight of bismuth carboxylate,
C) if desired, 0.1% to 10% by weight of auxiliaries and adjuvants, and
D) organic solvent to 100% by weight.

5. The dispersion as claimed in claim 2 comprising
A) 0.5% to 40% by weight of at least one agent having release activity, from the group consisting of soaps, oils, waxes, and silicones, and
B) 0.05% to 10% by weight of bismuth carboxylate,
C) if desired, 0.1% to 10% by weight of auxiliaries and adjuvants, and
D) organic solvent to 100% by weight.

6. The dispersion as claimed in claim 4, wherein the organic solvent is a hydrocarbon free of hydrochlorofluorocarbons which has a flash point between >55° C. and 200° C.

7. The dispersion as claimed in claim 5, wherein the organic solvent is a hydrocarbon free of hydrochlorofluorocarbons which has a flash point between >55° C. and 200° C.

8. A polyurethane molding with improved removability from a mold which comprises a polyurethane mold coated with the dispersion of claim 1.

9. The polyurethane molding of claim 8, wherein the dispersion has at least one bismuth carboxylate which comprises of at least one Bi(III) salt of organic acids R—COOH, where R is an optionally branched C₈ to C₂₂ hydrocarbon radical optionally containing multiple bonds.

10. The polyurethane molding of claim 9, wherein the at lease one bismuth carboxylate is bismuth trioctoate, bismuth trineodecanoate or mixtures thereof.

11. The polyurethane molding of claim 8, wherein the dispersion comprises:
A) 0.5% to 40% by weight of at least one agent having release activity, from the group consisting of soaps, oils, waxes, and silicones, and
B) 0.05% to 10% by weight of bismuth carboxylate,
C) if desired, 0.1% to 10% by weight of auxiliaries and adjuvants, and
D) organic solvent to 100% by weight.

12. The polyurethane molding of claim 9, wherein the dispersion comprises:
A) 0.5% to 40% by weight of at least one agent having release activity, from the group consisting of soaps, oils, waxes, and silicones, and
B) 0.05% to 10% by weight of bismuth carboxylate,
C) if desired, 0.1% to 10% by weight of auxiliaries and adjuvants, and
D) organic solvent to 100% by weight.

13. The polyurethane molding of claim 11, wherein the organic solvent of the dispersion is a hydrocarbon free of hydrochlorofluorocarbons which has a flash point between >55° C. and 200° C.

14. The polyurethane molding of claim 12, wherein the organic solvent of the dispersion is a hydrocarbon free of hydrochlorofluorocarbons which has a flash point between >55° C. and 200° C.

15. A method of improving the coverability of a polyurethane molding which comprises adding the dispersion of claim 1 to a polyurethane molding.

16. The method of claim 15, wherein the dispersion comprises:
A) 0.5% to 40% by weight of at least one agent having release activity, from the group consisting of soaps, oils, waxes, and silicones, and
B) 0.05% to 10% by weight of bismuth carboxylate,
C) if desired, 0.1% to 10% by weight of auxiliaries and adjuvants, and
D) organic solvent to 100% by weight.

17. The method of claim 16, wherein the dispersion has at least one bismuth carboxylate which comprises of at least one Bi(III) salt of organic acids R—COOH, where R is an optionally branched C₈ to C₂₂ hydrocarbon radical optionally containing multiple bonds.

18. The method of claim 17, wherein the at lease one bismuth carboxylate is bismuth trioctoate, bismuth trineodecanoate or mixtures thereof.

19. The method of claim 18, wherein the organic solvent of the dispersion is a hydrocarbon free of hydrochlorofluorocarbons which has a flash point between >55° C. and 200° C.
